(19) United States
(12) Patent Application Publication
(10) Pub. No.: US 2026/0334366 A1
(43) Pub. Date: Oct. 29, 2026

(54) MOVABLE STORAGE ASSEMBLY FOR A RIDING LAWN CARE VEHICLE

(71) Applicant: HUSQVARNA AB, Huskvarna (SE)

(72) Inventor: Daniel Kelly KIESZ, Charlotte, NC (US)

(21) Appl. No.: 19/113,560

(22) PCT Filed: Dec. 19, 2022
(86) PCT No.: PCT/US2022/053341

§ 371 Date: Mar. 20, 2025

Related U.S. Application Data
(60) Provisional application No. 63/408,594, filed on Sep. 21, 2022.

(51) Int. Cl. A01D 75/00; A01D 34/64; A01D 101/00

(52) U.S. Cl. CPC A01D 75/008; A01D 34/64; A01D 2101/00

(57) ABSTRACT

A riding lawn care vehicle may include a. frame to which wheels of the riding lawn care vehicle may be attachable, a. power source operably coupled to the frame, wherein the power source may provide power to the wheels, a seat which an operator of the riding lawn care vehicle may utilize when operating the riding lawn care vehicle, a steering assembly which may be operably coupled to the wheels, and a. movable storage assembly which may be operably coupled to the frame. The movable storage assembly may include a storage bin to retain objects therein, and an engagement assembly operably coupling the storage bin to the frame. The engagement assembly may translate the storage bin between a forward position and an aft position. In the aft position, the storage bin may pivot to a pivoted position via the engagement assembly.

### TECHNICAL FIELD

Example embodiments generally relate to lawn care vehicles and, more particularly, to riding lawn care vehicles with an attached storage assembly.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small power sources, and are relatively inexpensive. Meanwhile, at the other end of the spectrum, riding lawn mowers, such as lawn tractors, can be quite large. Riding lawn mowers provide the convenience of a riding vehicle as well as a typically larger cutting deck as compared to a walk-behind model. Riding lawn mowers can sometimes also be configured with various functional accessories (e.g., trailers, tillers, and/or the like) in addition to grass cutting components.

Some riding lawn care vehicles may be configured with a storage assembly. The storage assembly may hold various objects or materials that may be useful or otherwise desirable to have while performing a lawn care task. In some cases, an operator of the riding lawn care vehicle may wish to utilize the storage bin for many different purposes. Thus, an improved storage assembly that is more versatile for various use cases may be desired.

### BRIEF SUMMARY OF SOME EXAMPLES

In one example embodiment, a movable storage assembly for a riding lawn care vehicle is provided. The movable storage assembly may include a storage bin to retain objects therein, and an engagement assembly operably coupling the storage bin to a frame of the riding lawn care vehicle. The engagement assembly may translate the storage bin between a forward position and an aft position. In the aft position, the storage bin may pivot to a pivoted position via the engagement assembly.

In another example embodiment, a riding lawn care vehicle may be provided. The riding lawn care vehicle may include a frame to which wheels of the riding lawn care vehicle may be attachable, a power source operably coupled to the frame, wherein the power source may provide power to the wheels, a seat which an operator of the riding lawn care vehicle may utilize when operating the riding lawn care vehicle, a steering assembly which may be operably coupled to the wheels, and a movable storage assembly which may be operably coupled to the frame. The movable storage assembly may include a storage bin to retain objects therein, and an engagement assembly operably coupling the storage bin to the frame. The engagement assembly may translate the storage bin between a forward position and an aft position. In the aft position, the storage bin may pivot to a pivoted position via the engagement assembly.

### BRIEF DESCRIPTION OF THE SEVERAL VIEWS OF THE DRAWING(S)

Having thus described some embodiments of the present invention in general terms, reference will now be made to the accompanying drawings, which are not necessarily drawn to scale, and wherein:

FIG. 1A illustrates a perspective view of a riding lawn care vehicle according to an example embodiment;

FIG. 1B illustrates a top view of the riding lawn care vehicle according to an example embodiment;

FIG. 2 illustrates a perspective view of a steering assembly with steering levers positioned to be pulled back for rearward propulsion according to an example embodiment;

FIG. 3 illustrates a perspective view of a riding lawn care vehicle according to an example embodiment;

FIG. 4 illustrates a rear view of the riding lawn care vehicle according to an example embodiment;

FIG. 5 illustrates a partial side view of the riding lawn care vehicle according to an example embodiment;

FIG. 6 illustrates a perspective view of a movable storage assembly according to an example embodiment;

FIG. 7 illustrates a perspective view of an engagement assembly according to an example embodiment;

FIG. 8A illustrates a perspective view of an engagement assembly according to an example embodiment;

FIG. 8B illustrates a perspective view of an engagement assembly according to an example embodiment;

FIG. 9 illustrates a perspective view of an engagement assembly according to an example embodiment;

FIG. 10 illustrates a partial perspective view of an engagement assembly according to an example embodiment;

FIG. 11 illustrates a partial perspective view of a rail system according to an example embodiment; and

FIG. 12 illustrates a perspective view of the movable mount according to an example embodiment.

### DETAILED DESCRIPTION

Some example embodiments now will be described more fully hereinafter with reference to the accompanying drawings, in which some, but not all example embodiments are shown.

Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, the phrase “operable coupling” and variants thereof should be understood to relate to direct or indirect connection that, in either case, enables functional interconnection of components that are operably coupled to each other.

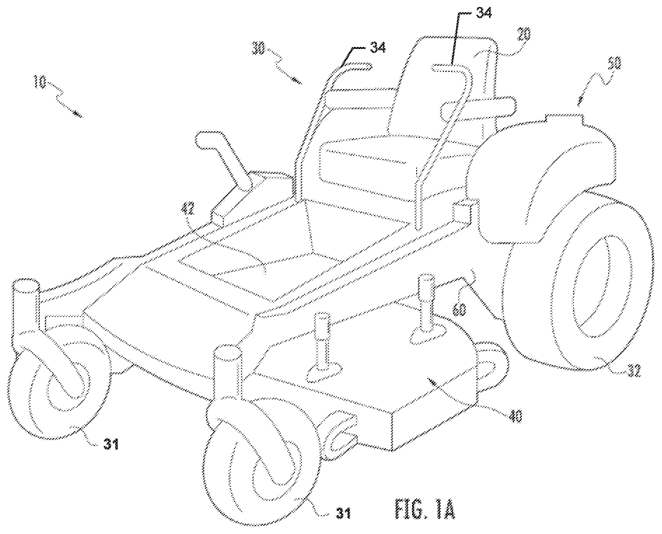

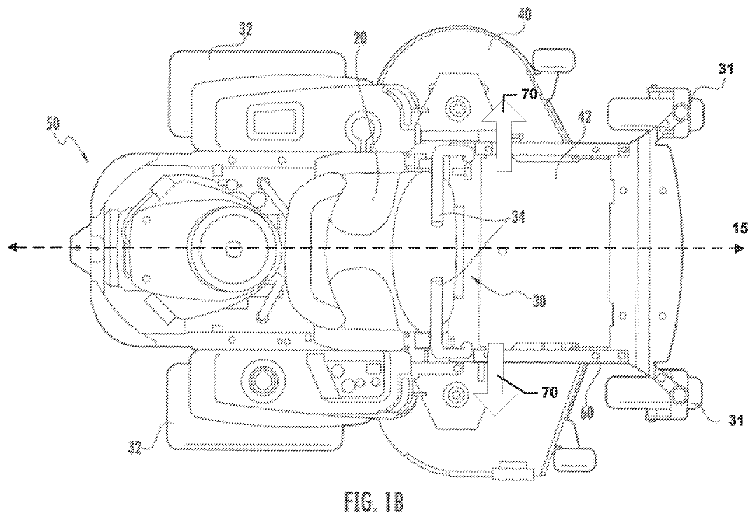

FIG. 1, which includes FIG. 1A and 1B, illustrates a riding lawn care vehicle 10 according to an example embodiment. FIG. 1A illustrates a perspective view of the riding lawn care vehicle 10, and FIG. 1B illustrates a top view of the riding lawn care vehicle 10 according to an example embodiment. In some embodiments, the riding lawn care vehicle 10 may include a seat 20 that may be disposed at a center, rear, or front portion of the riding lawn care vehicle 10. The riding lawn care vehicle 10 may also include a steering assembly 30 (e.g., a set of steering levers or the like) functionally connected to wheels 31 and/or 32 of the riding lawn care vehicle 10 to allow the operator to steer the riding lawn care vehicle 10. The riding lawn care vehicle 10 of FIG. 1B may also include a longitudinal axis 15 that may extend down the center of the riding lawn care vehicle 10, parallel to a straight forward direction of motion. The longitudinal axis 15 may divide the riding lawn care vehicle 10 into two equal halves accordingly.

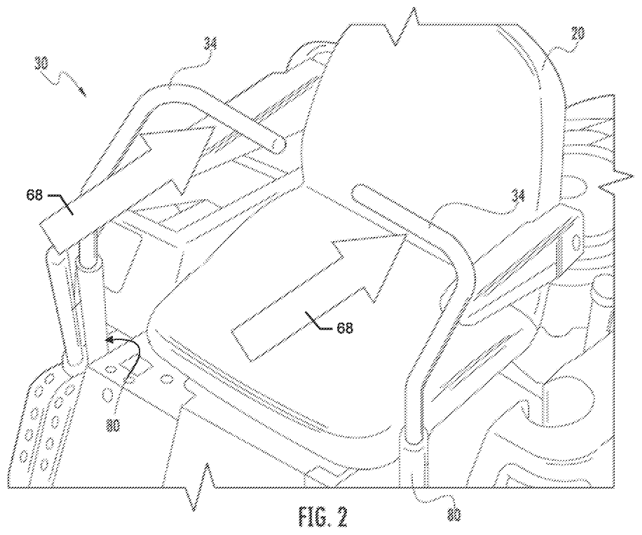

FIG. 2 illustrates a perspective view of a steering assembly with steering levers positioned to be pulled back for rearward propulsion according to an example embodiment. Referring to FIGS. 1 and 2, the operator may sit on the seat 20, which may be disposed to the rear of the steering assembly 30 to provide input for steering of the riding lawn care vehicle 10 via the steering assembly 30. However, some models may be stand-up models that eliminate the seat 20. If the seat 20 is eliminated, the operator may stand at an operator station proximate to the steering assembly 30. In an example embodiment, the steering assembly 30 may include separately operable steering levers 34 shown specifically in FIG. 1B and FIG. 2.

The riding lawn care vehicle 10 may also include a cutting deck 40 having at least one cutting blade (e.g., three cutting blades) mounted therein. The cutting deck 40 may be positioned substantially rearward of a pair of front wheels 31 and substantially forward of a pair of rear wheels 32 in a position to enable the operator to cut grass using the cutting blade(s) when the cutting blade(s) are rotated below the cutting deck 40 when the cutting deck 40 is in a cutting position. However, in some alternative examples, the cutting deck 40 may be positioned in front of the front wheels 31. In some embodiments, a footrest 42 may also be positioned above the cutting deck 40 forward of the seat 20 to enable the operator to rest his or her feet thereon while seated in the seat 20. In embodiments that do not include the seat 20, the footrest 42 may form the operator station from which a standing operator controls the riding lawn care vehicle 10. When operating to cut grass, the grass clippings may be captured by a collection system, mulched, or expelled from the cutting deck 40 via either a side discharge or a rear discharge.

In the pictured example embodiment, a power source 50 of the riding lawn care vehicle 10 is disposed to the rear of a seated operator. However, in other example embodiments, the power source 50 could be in different positions such as in front of or below the operator. As shown in FIG. 1, the power source 50 may be operably coupled to one or more of the wheels 31 and/or 32 to provide drive power for the riding lawn care vehicle 10. In an example embodiment, the power source 50 may be an internal combustion engine (ICE) that may be operably coupled to the frame. In some other cases, the power source 50 may be a battery pack operably coupled to the frame and may power one or more electric motors. The power source 50, the steering assembly 30, the cutting deck 40, the seat 20, and other components of the riding lawn care vehicle 10 may be operably connected (directly or indirectly) to a frame 60 of the riding lawn care vehicle 10. The frame 60 may be a rigid structure to provide support, connectivity, and/or interoperability functions for various ones of the components of the riding lawn care vehicle 10.

In some example embodiments, the steering assembly 30 may be embodied as an assembly of metallic and/or other rigid components that may be welded, bolted, and/or otherwise attached to each other and operably coupled to the wheels of the riding lawn care vehicle 10 to which steering inputs are provided (e.g., rear wheels 32). For example, the steering assembly 30 may include or otherwise be coupled with hydraulic or electric motors that independently power one or more drive wheels (e.g., rear wheels 32) on each respective side of the riding lawn care vehicle 10. The steering levers 34 may be operable to move forward (i.e., in a direction opposite arrow 68 in FIG. 2) and rearward (i.e., in the direction shown by arrow 68 in FIG. 2) of a neutral position while in the inboard position (shown in both FIGS. 1 and 2). When a steering lever 34 is pushed forward of the neutral position (e.g., away from the operator an opposite the direction of arrow 68), the corresponding hydraulic or electric motor may drive the corresponding wheel forward. When a steering lever 34 is pulled rearward of the neutral position (e.g., toward the operator as shown by the direction of arrows 68 in FIG. 2), the corresponding hydraulic or electric motor may drive the corresponding wheel backward. Thus, when both steering levers 34 are pushed forward of the neutral position the same amount, the riding lawn care vehicle 10 travels forward in substantially a straight line because approximately the same amount of forward drive input is provided to each drive wheel. When both steering levers 34 are pulled back relative to the neutral position the same amount, the riding lawn care vehicle 10 travels backward (e.g., rearward) in substantially a straight line because approximately the same amount of rearward drive input is provided to each drive wheel. When one steering lever 34 is pushed forward and the other steering lever 34 is pulled back, the riding lawn care vehicle 10 begins to turn in a circle and/or spin. Steering right and left may be accomplished by providing uneven amounts of input to the steering levers 34, Other steering control systems may be employed in some alternative embodiments.

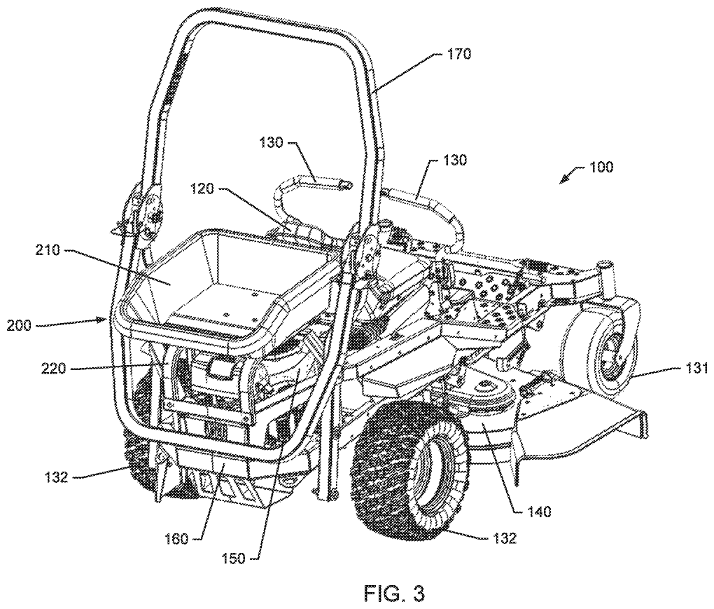

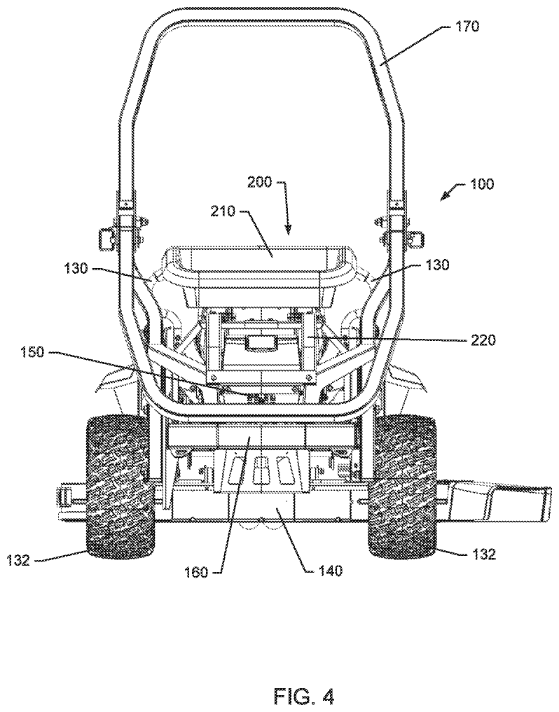

Although the steering levers 34 are generally moved forward (i.e., opposite the direction of the arrows 68 shown in FIG. 2) or backward (i.e., in the direction of the arrows 68 shown in FIG. 2) in any desirable combination while they are in the operating positions shown in FIGS. 1 and 2, it should be appreciated that the steering levers 34 may also be moved to an outboard position (e.g., in a non-operational state) by moving the steering levers 34 outwardly in the direction shown by arrows 70 in FIG. 1B. In this regard, although the steering levers 34 are shown in the inboard (or operational) position in FIGS. 1 and 2, the steering levers 34 may be moved in the direction of arrows 70 (i.e., outboard) relative to their inboard position and into a non-operational position. In some cases, each of the steering levers 34 may be operably coupled to respective lever mounts 80 that may pivot to enable the steering levers 34 to move outwardly (e.g., to the outboard position) or inwardly (e.g., to an inboard and/or operating position). In some embodiments, when at least one (and sometimes both) of the steering levers 34 is pivoted outwardly, brakes may be applied and the operator may easily mount or dismount the riding lawn care vehicle 10 and sit in or leave the seat 20. While FIGS. 1A, 1B and 2 illustrate a generic view of a riding lawn care vehicle 10, FIGS. 3-12 illustrate a particular example embodiment of a riding lawn care vehicle 100 including specific components that may or may not have been described above in reference to a generic riding lawn care vehicle 10. Accordingly, FIGS. 3 and 4 illustrate perspective and rear views of a riding lawn care vehicle 100 according to an example embodiment. In the example embodiment shown in FIGS. 3 and 4, the riding lawn care vehicle 100 may include a seat 120, a steering assembly 130, front wheels 131, rear wheels 132, a cutting deck 140, a power source 150 and a frame 160. In the embodiment shown in FIG. 3, the above components of the riding lawn care vehicle 100 may have the same or similar functions as described above in reference to the embodiment shown in FIGS. 1A, 1B and 2. The riding lawn care vehicle of FIGS. 3 and 4 may further include a rollover protection system 170. The rollover protection system 170 may be operably coupled to the frame 160 and may support the weight of the riding lawn care vehicle 100 in the event that the riding lawn care vehicle 100 rolls over. In other words, the rollover protection system 170 may act as a roll-cage or roll-bar of sorts. As such, the operator that may be sitting in seat 120 to operate the riding lawn care vehicle 100 may be protected from the riding lawn care vehicle 100 by the rollover protection system 170 in the event that the riding lawn care vehicle 100 has been overturned. In some cases, the rollover protection system 170 may be folded down into a low profile position. This may be useful in the event that the riding lawn care vehicle 100 may be operated in a setting with low overhead clearance and little to no risk of overturning the riding lawn care vehicle 100.

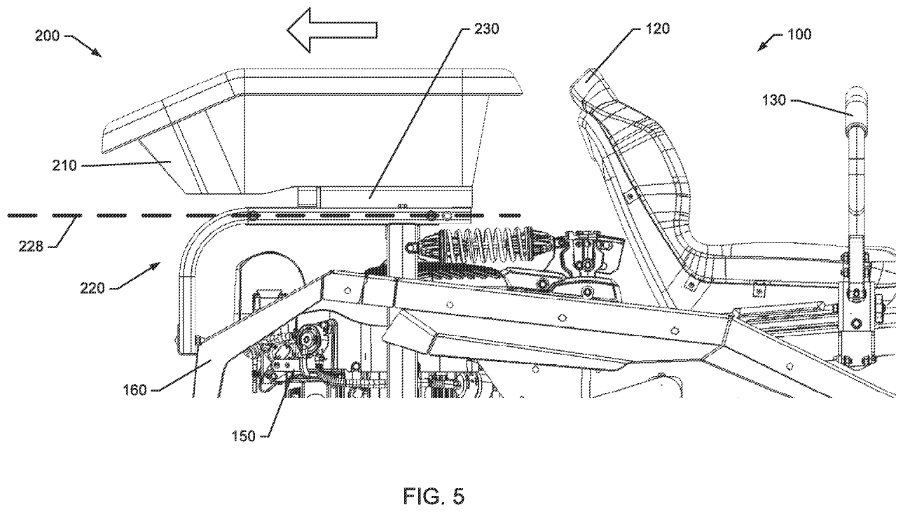

FIG. 5 illustrates a partial side view of the riding lawn care vehicle 100 according to an example embodiment. Separate from the rollover protection system 170, the riding lawn care vehicle 100 may further include a movable storage assembly 200. In some cases, the movable storage assembly 200 may be disposed behind the seat 120 and above the power source 150 of the riding lawn care vehicle 100. The movable storage assembly 200 may also be disposed within the rollover protection system 170, but may not interfere with any operations of the rollover protection system 170. In an example embodiment, the movable storage assembly 200 may be an optional accessory that may be added to riding lawn care vehicles 100 which may not be already equipped with one. In this regard, the movable storage assembly 200 may include a storage bin 210 and an engagement assembly 220 that may operably couple the storage bin 210 the frame 160 of the riding lawn care vehicle 100. The storage bin 210 may, in some cases, be open on top storage bin 210 capable of holding a variety of objects or materials therein during operation of the riding lawn care vehicle 100. In an example embodiment, the storage bin 210 may be formed from a plastic polymer material via an injection molding process. In other cases, the storage bin 210 may be formed from any suitable material capable of maintaining its shape in a variety of environments and use cases. In an example embodiment, the storage bin 210 may be open on top in order to allow easy access in and out of the storage bin 210 to the contents held therein. In other cases, the storage bin 210 may include a lid to better retain the contents of the storage bin 210 within the storage bin 210.

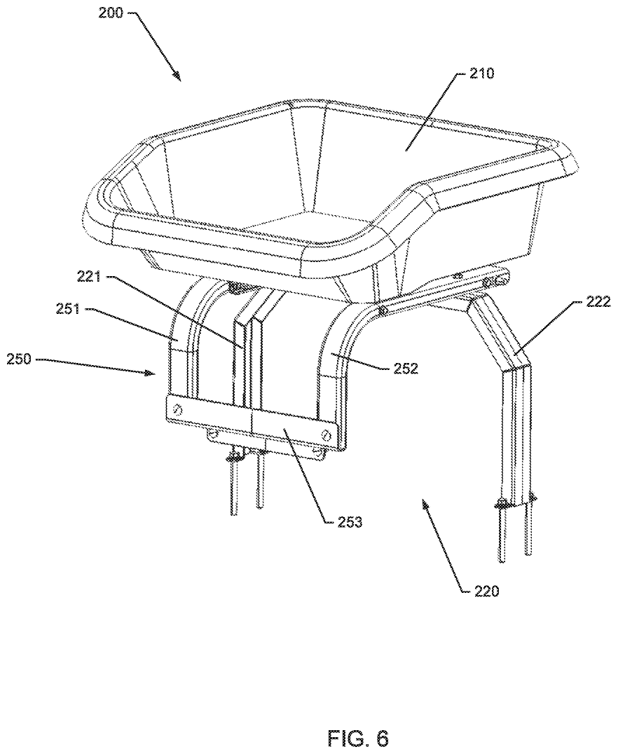

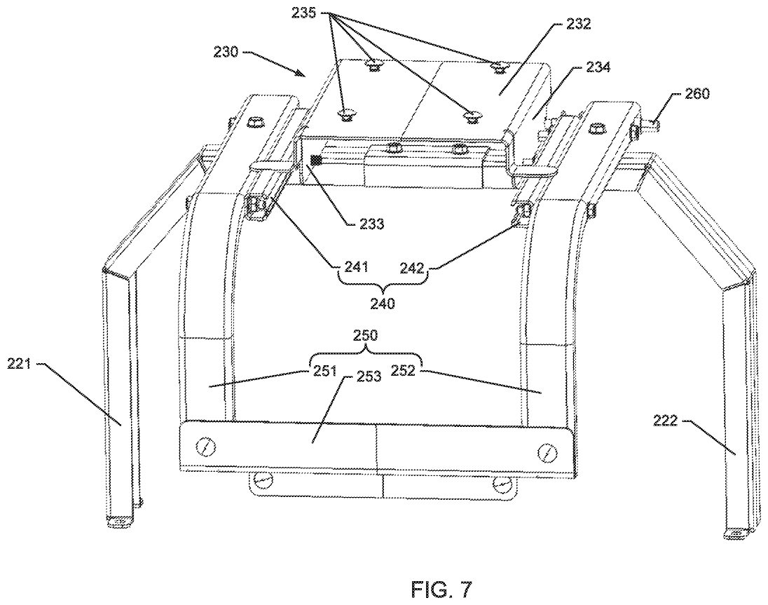

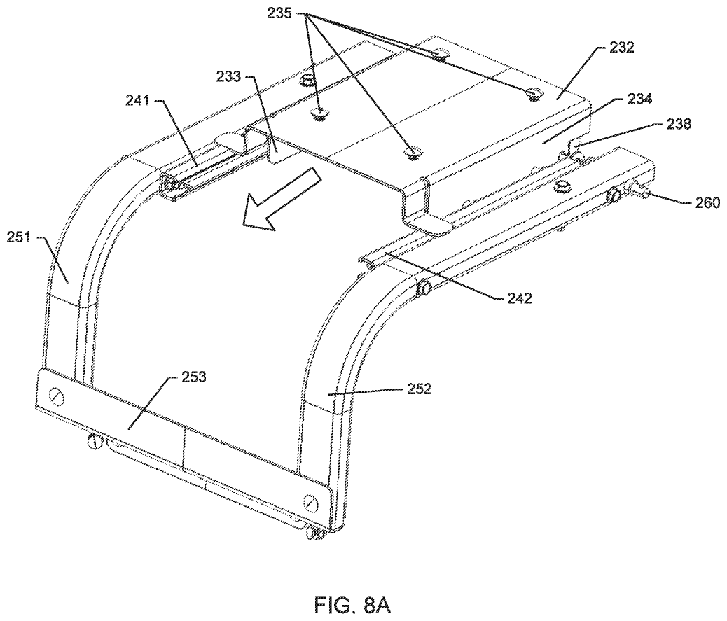

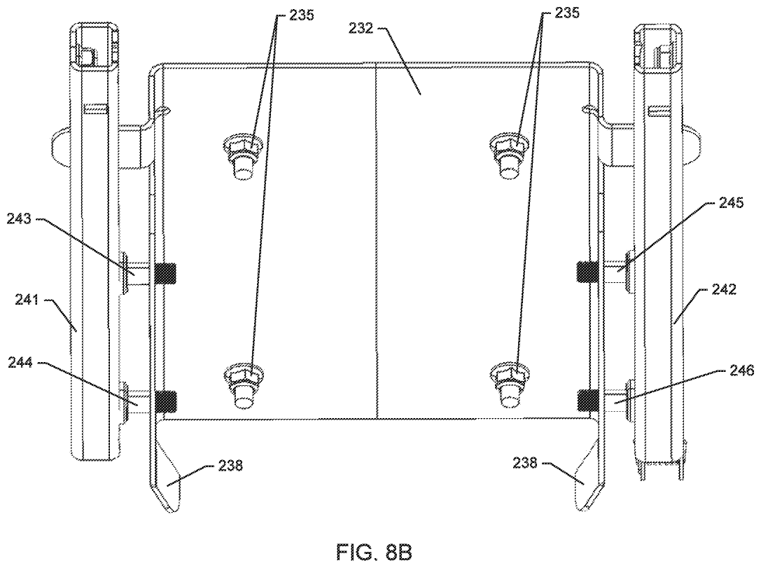

FIG. 6 illustrates a perspective view of the movable storage assembly 200 according to an example embodiment, and FIGS. 7, 8A and 8B illustrate perspective views of the engagement assembly 220 according to an example embodiment. In some embodiments, the engagement assembly 220 may include a movable mount 230 and a rail system 240. The movable mount 230 may operably couple the storage bin 210 to the rail system 240. In this regard, the movable mount 230 may be formed from a sheet of metal or other suitable material that may be bent or otherwise formed into shape. The movable mount 230 may thus include a planar surface 232, a first side 233 and a second side 234. The first and second sides (233, 234) may extend perpendicularly down from the planar surface 232 on opposing sides of the movable mount 230. The movable mount 230 may be operably coupled to an underside of the storage bin 210 using one or more fasteners 235. The first and second sides (233, 234) of the movable mount 230 may be slidably operably coupled to the rail system 240. As such, the movable mount 230, and therefore the storage bin 210, may be movable between a forward position and an aft position due to the slidable operable coupling between the movable mount 230 and the rail system 240. The operable coupling between the movable mount 230 and the rail system 240 may define a translation plane 228. The movable mount 230 may accordingly translate between the forward and aft positions within the translation plane 228. The translation plane 228 may thus bisect the rail system 240 into upper and lower portions.

The rail system 240 may include a first rail 241 and a second rail 242. The first and second rails (241, 242) may be disposed on opposite sides of, and parallel to, the longitudinal axis of the riding lawn care vehicle 100. In some cases, the first and second rails (241, 242) may each include the upper portion and the lower portion, which may be separated by the translation plane 228, and a central portion which may extend normal to, and through, the translation plane 228. In this regard, the upper portion and the lower portion may form a substantially “C” shaped tunnel together with the central portion. In other words, the upper and lower portions may be substantially planar portions of the first and second rails (241, 242) that may extend normal to the central portion of the rail. The central portion of the rail may also operably couple the first and second rails (241, 242) to the frame 160 via fasteners which may be disposed at distal ends of the first and second rails (241, 242).

Each of the first and second rails (241, 242) may also retain a pair of wheels within the tunnel. In this regard, the movable mount may be operably coupled to the rail system by first, second, third and fourth wheels (243, 244, 245, 246). In some cases, the first, second, third and fourth wheels (243, 244, 245, 246) may be retained within the respective tunnels, and may roll along the rail system 240 to move the movable mount 230, and thus the storage bin 210 attached thereto, between the forward and aft positions within the translation plane 228. Accordingly, the first and second wheels (243, 244) may operably couple the first side 233 to the first rail 241, and the third and fourth wheels (245, 246) may operably couple the second side 234 to the second rail 242.

In some cases, the engagement assembly 220 may further include first and second frame supports (221, 222) and a bin guide 250. In an example embodiment, the bin guide 250 may include a first guide member 251 operably coupled to the first rail 241, a second guide member 252 operably coupled to the second rail 242 and a cross member 253 extending perpendicularly between the first and second guide members (251, 252). In some cases, the first and second frame supports (221, 222) may operably couple the first and second guide members (251, 252) to the frame 160, and therefore may operably couple the first and second rails (241, 242) to the frame 160 via the first and second guide members (251, 252). In an example embodiment, the first and second guide members (251, 252) of the bin guide 250 may curve downward at roughly 90° such that the cross member 253 may be disposed below the rail system 240. In this regard, the first and second guide members (251, 252) may include a horizontal portion and a vertical portion. The horizontal portion of the first and second guide members (251, 252) may be the portion of the members to which the first and second rails (241, 242) are operably coupled. As such, the horizontal portion of the first and second guide members (251, 252) may be disposed in the translation plane 228. Accordingly, the vertical portion of the first and second guide members (251, 252) may be disposed proximate to where the storage bin 210 may rest while in the aft position, substantially behind the power source 150 of the riding lawn care vehicle 100, and normal to the translation plane 228. In an example embodiment, the cross member 253 may operably couple the bin guide 250 to the frame 160. In this regard, the first and second guide members (251, 252) of the bin guide 250 may be operably coupled to the frame 160 at both ends of each respective member.

The first and second guide members (251, 252) may be curved between the horizontal portion and the vertical portion. In this regard, the curve of the first and second guide members (251, 252) may be rounded and may not form a right angle between the horizontal and vertical portions, and the storage bin 210 may interface with the curve of the first and second guide members (251, 252).

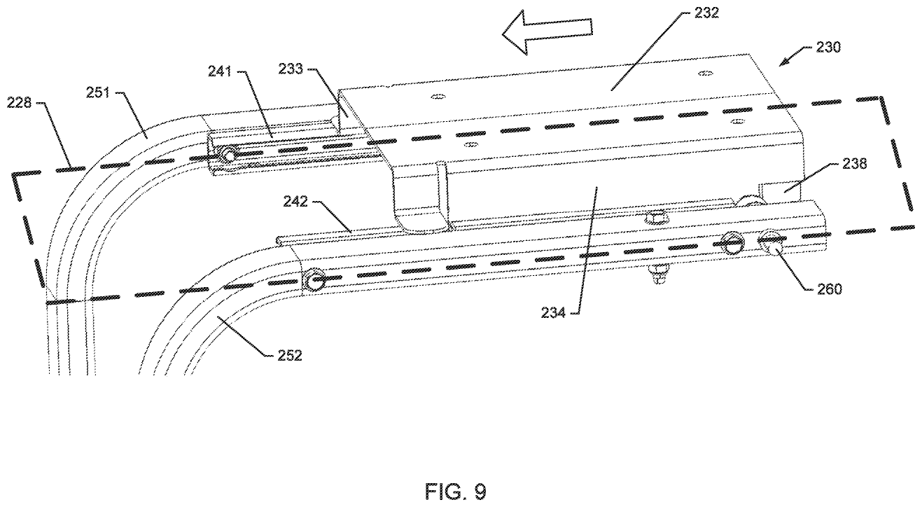

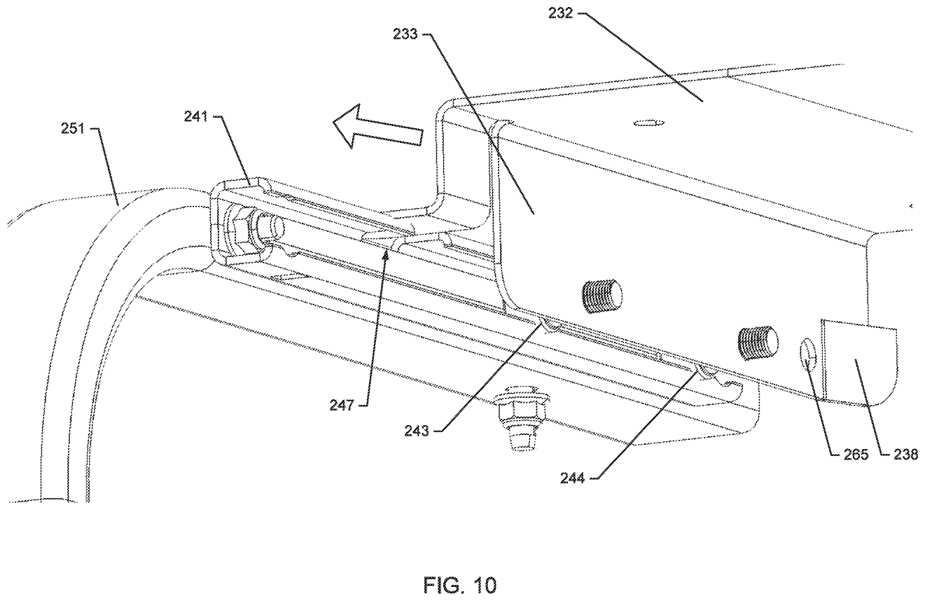

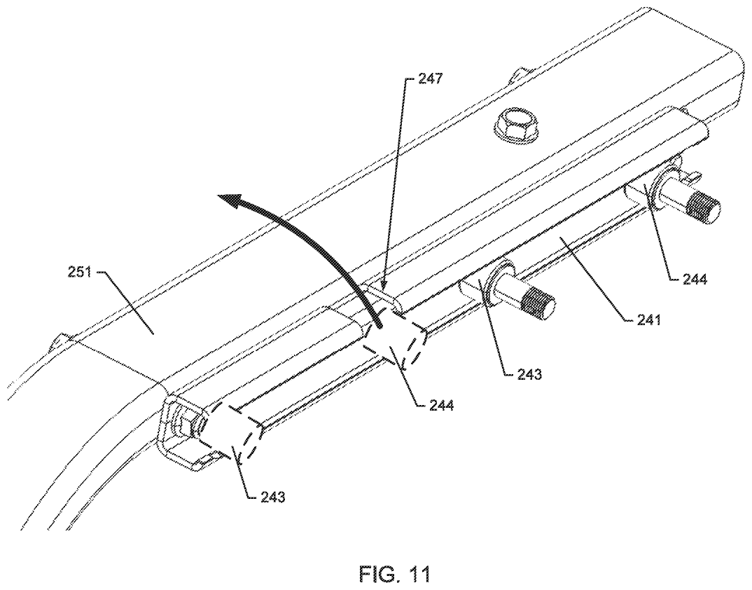

FIGS. 9 and 10 illustrate perspective views of the engagement assembly 220 according to an example embodiment, and FIG. 11 illustrates a perspective view of the first rail 241 according to an example embodiment. In the example embodiment of FIGS. 9-11, and as described above, the first and second wheels (243, 244) may operably couple the first side 233 to the first rail 241, and the third and fourth wheels (245, 246) may operably couple the second side 234 to the second rail 242. Thus, the movable mount 230 may move between the forward and aft positions within the translation plane 228 as a result of the first, second, third and fourth wheels (243, 244, 245, 246) rolling within their respective rails of the rail system 240. In some cases, the first and second rails (241, 242) may include first and second slots (247, 248), respectively. In this regard, the first and second slots (247, 248) may be disposed on the upper portion of the first and second rails (241, 242). Thus, the first, second, third and fourth wheels (243, 244, 245, 246) may roll along the lower portion of the first and second rails (241, 242) without being interrupted by the first and second slots (247, 248) as the movable mount 230 moves between the forward and aft positions.

While the storage bin 210 may be in the aft position, the first and third wheels (243, 245) may be positioned at an end of the first and second rails (241, 242), respectively, that may be proximate to the vertical portion of the first and second guide members (251, 252). In this regard, the first and third wheels (243, 245) may be in contact with respective fasteners used to secure the first and second rails (241, 242) to the first and second guide members (251, 252) of the bin guide 250. Accordingly, the first and third wheels (243, 245) may be held in place in contact with fasteners within the first and second rails (241, 242), respectively, by the weight distribution of the storage bin 210 in the aft position. Still in the aft position, the second and fourth wheels (244, 246) may align with the first and second slots (247, 248), respectively. In some cases, the storage bin 210 may pivot rearward to a pivoted position out of the translation plane 228 from the aft position. To pivot to the pivoted position, the storage bin 210 may thus pivot about a pivot axis extending through the first and third wheels (243, 245) while the first and third wheels (243, 245) are held in place. In this regard, responsive to the storage bin 210 (and thus the movable mount 230 secured thereto) pivoting about the pivot axis, the second and fourth wheels (244, 246) may exit the first and second rails (241, 242), respectively, through the first and second slots (247, 248) in the upper portion thereof. Thus, the second and fourth wheels (244, 246) may also exit the translation plane 228, accordingly.

As such, the act of moving the storage bin 210 into the pivoted position from the aft position may be described as a dumping motion. In this regard, any contents held within the storage bin 210 may be dumped out of the storage bin 210 behind the riding lawn care vehicle 100 as the storage bin 210 pivots into the pivoted position. In some cases, the storage bin 210 may rest on the curve of the first and second guide members (251, 252) of the bin guide 250 while the storage bin 210 may be in the pivoted position. In this regard, the bin guide 250 may guide the storage bin 210 to the pivoted position. The storage bin 210 may remain in the pivoted position due to a center of mass of the storage bin 210 being further aft of the pivot axis that extends through the first and third wheels (243, 245). As such, the storage bin 210 may not need to be held or actively biased into the pivoted position by the operator. To re-enter the aft position from the pivoted position, the storage bin 210 may pivot towards the horizontal portion of the first and second guide members (251, 252) of the bin guide 250. Upon pivoting down, the second and fourth wheels (244, 246) may re-enter the first and second rails (241, 242), respectively, through the first and second slots (247, 248).

Responsive to re-entering the first and second rails (241, 242), the movable mount 230 may roll back on the first, second, third and fourth wheels (243, 244, 245, 246) along the rail system 240 into the forward position.

In some cases, the movable mount 230, and thus the storage bin 210 operably coupled thereto, may be removed from the rail system 240 entirely. In this regard, the movable mount 230 may be removed from the rail system 240 two wheels at a time through the first and second slots (247, 248). Accordingly, either the first and third wheels (243, 245) or the second and fourth wheels (244, 246) may be lifted through the first and second slots (247, 248), followed by the other respective set of wheels thereafter. As such, the storage bin 210 and the movable mount 230 may be removed from the rest of the engagement assembly 220, and thus from the riding lawn care vehicle 100, without the use of any tools.

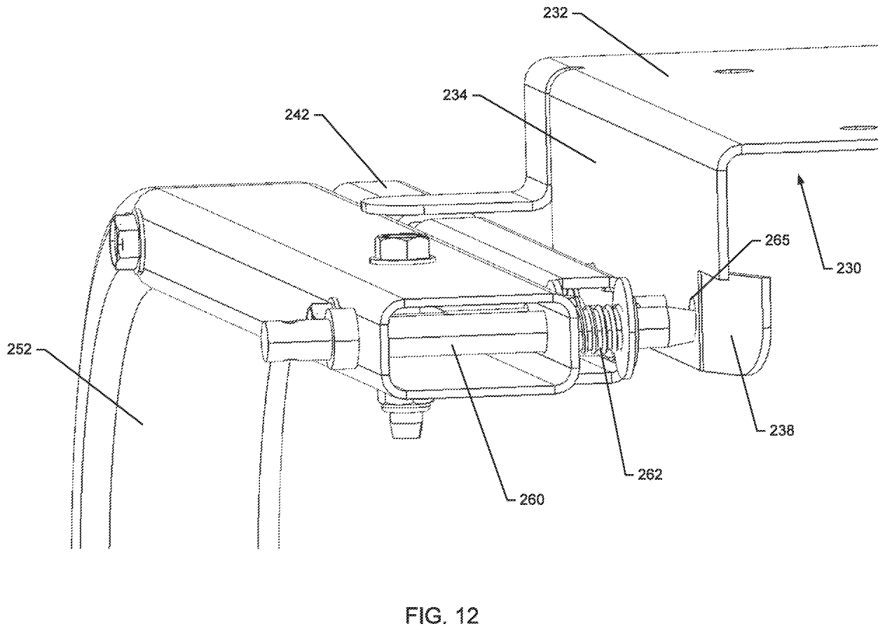

FIG. 12 illustrates a perspective view of the movable mount 230 according to an example embodiment. In FIG. 12, the movable storage assembly 200 may further include a retention pin 260 to retain the movable mount 230 in the forward position. In this regard, the retention pin 260 may be biased via a spring 262 towards the movable mount 230. Accordingly, responsive to the movable mount 230 moving into the forward position, the retention pin 260 may automatically be inserted into a retention orifice 265 disposed on either or both of the first and second sides (233, 234) of the movable mount 230. Thus, in order to move the movable mount 230 from the forward position to the aft position, the operator may apply a force to the retention pin 260 to oppose the bias from the spring 262 and pull the retention pin 260 back out of the retention orifice 265. Responsive to the retention pin 260 exiting the retention orifice 265, the movable mount 230 may be free to translate to the aft position. In some embodiments, the movable mount 230 may include a sloped surface 238 that may guide the retention pin 260 into the retention orifice 265 responsive to the movable mount 230 moving into the forward position. The retention pin 260 may hold the movable mount 230 in the forward position where it may be unable to move to the aft position or pivot into the pivoted position unintentionally during operation of the riding lawn care vehicle 100.

Some example embodiments may provide for a movable storage assembly for a riding lawn care vehicle. The movable storage assembly may include a storage bin to retain objects therein, and an engagement assembly operably coupling the storage bin to a frame of the riding lawn care vehicle. The engagement assembly may be to translate the storage bin between a forward position and an aft position. In the aft position, the storage bin may be to pivot to a pivoted position via the engagement assembly.

The movable storage assembly of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the engagement assembly may include a movable mount and a rail system. In some cases, the rail system may be operably coupled to the frame. In an example embodiment, the movable mount may operably couple the storage bin to the rail system. In some cases, the rail system may include a first rail and a second rail. In an example embodiment, the first and second rails may be disposed on opposite sides of, and parallel to, a longitudinal axis of the riding lawn care vehicle. In some cases, the movable mount may include a planar surface to which the storage bin may operably couple to via one or more fasteners. In an example embodiment, the movable mount may be operably coupled to the rail system by first, second, third and fourth wheels. In some cases, the first, second, third and fourth wheels may roll within the rail system to move the movable mount between the forward and aft positions. In an example embodiment, the first and second wheels may be operably coupled to the first rail, and the third and fourth wheels may be operably coupled to the second rail. In some cases, the first and second rails may include first and second slots, respectively. In an example embodiment, the second and fourth wheels may align with the first and second slots, respectively, while the storage bin may be in the aft position. In some cases, the storage bin may pivot rearward to the pivoted position about the first and third wheels. In an example embodiment, the second and fourth wheels may exit the first and second rails, respectively, through the first and second slots responsive to the storage bin pivoting about the first and third wheels. In some cases, the engagement assembly may further include first and second frame supports and a bin guide. In an example embodiment, the bin guide may include a first guide member operably coupled to the first rail, a second guide member operably coupled to the second rail and a cross member disposed perpendicularly between the first and second guide members. In some cases, the first and second frame supports may operably couple the first and second guide members to the frame. In an example embodiment, the first and second guide members of the bin guide may curve downward at roughly 90° such that the cross member may be disposed below the rail system. In some cases, the storage bin may rest on the first and second guide members of the bin guide while the storage bin may be in the pivoted position. In an example embodiment, the movable storage assembly may further include a retention pin to retain the movable mount in the forward position. In some cases, the movable storage assembly may be disposed within, and may not interfere with the operation of, a rollover protection system of the riding lawn care vehicle. In an example embodiment, the storage bin may be removable from the riding lawn care vehicle responsive to the first, second, third and fourth wheels exiting the first and second rails through the first and second slots.

Some example embodiments may provide for a riding lawn care vehicle. The riding lawn care vehicle may include a frame to which wheels of the riding lawn care vehicle may be attachable, a power source operably coupled to the frame, wherein the power source may provide power to the wheels, a seat which an operator of the riding lawn care vehicle may utilize when operating the riding lawn care vehicle, a steering assembly which may be operably coupled to the wheels, and a movable storage assembly which may be operably coupled to the frame. The movable storage assembly may include a storage bin to retain objects therein, and an engagement assembly operably coupling the storage bin to the frame. The engagement assembly may translate the storage bin between a forward position and an aft position. In the aft position, the storage bin may pivot to a pivoted position via the engagement assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

That which is claimed:

1. A movable storage assembly for a riding lawn care vehicle, the movable storage assembly comprising:
a storage bin to retain objects therein, and
an engagement assembly operably coupling the storage bin to a frame of the riding lawn care vehicle,
wherein the engagement assembly translates the storage bin within a translation plane between a forward position and an aft position, and
wherein in the aft position, the storage bin pivots out of the translation plane to a pivoted position via the engagement assembly.

2. The movable storage assembly of claim 1, wherein the engagement assembly comprises a movable mount and a rail system,
wherein the rail system is operably coupled to the frame, and
wherein the movable mount operably couples the storage bin to the rail system.

3. The movable storage assembly of claim 2, wherein the movable mount comprises a planar surface to which the storage bin operably couples to via one or more fasteners.

4. The movable storage assembly of claim 2, wherein the rail system comprises a first rail and a second rail,
wherein the first and second rails are disposed on opposite sides of, and parallel to, a longitudinal axis of the riding lawn care vehicle, and
wherein the first and second rails are disposed in the translation plane.

5. The movable storage assembly of claim 4, wherein the movable mount is operably coupled to the rail system by first, second, third and fourth wheels,
wherein the first, second, third and fourth wheels roll within the rail system to move the movable mount between the forward and aft positions, and
wherein the first and second wheels are operably coupled to the first rail, and the third and fourth wheels are operably coupled to the second rail.

6. The movable storage assembly of claim 5, wherein the first and second rails comprise first and second slots, respectively,
wherein the second and fourth wheels align with the first and second slots, respectively, while the storage bin is in the aft position to enable the storage bin to pivot rearward to the pivoted position about the first and third wheels, and
wherein the second and fourth wheels exit the first and second rails, respectively, through the first and second slots responsive to the storage bin pivoting about the first and third wheels.

7. The movable storage assembly of claim 6, wherein the engagement assembly further comprises first and second frame supports and a bin guide,
wherein the bin guide comprises a first guide member operably coupled to the first rail, a second guide member operably coupled to the second rail and a cross member disposed perpendicularly between the first and second guide members,
wherein the first and second frame supports operably couple the first and second guide members to the frame,

8. The movable storage assembly of claim 7, wherein the first and second guide members of the bin guide curve downward at roughly 90° such that the cross member is disposed below the rail system,
wherein the storage bin rests on the first and second guide members of the bin guide while the storage bin is in the pivoted position.

9. The movable storage assembly of claim 6, wherein the storage bin is removable from the riding lawn care vehicle responsive to the first, second, third and fourth wheels exiting the first and second rails through the first and second slots.

10. The movable storage assembly of claim 1, wherein the movable storage assembly further comprises a retention pin to retain the movable mount in the forward position.

11. A riding lawn care vehicle comprising:
a frame to which wheels of the riding lawn care vehicle are attachable;
a power source operably coupled to the frame, wherein the power source provides power to the wheels;
a seat for an operator of the riding lawn care vehicle to utilize when operating the riding lawn care vehicle;
a steering assembly operably coupled to the wheels; and
a movable storage assembly operably coupled to the frame,
wherein the movable storage assembly comprises:
a storage bin to retain objects therein, and
an engagement assembly operably coupling the storage bin to the frame,
wherein the engagement assembly translates the storage bin within a translation plane between a forward position and an aft position, and
wherein in the aft position, the storage bin pivots out of the translation plane to a pivoted position via the engagement assembly.

12. The riding lawn care vehicle of claim 11, wherein the engagement assembly comprises a movable mount and a rail system,
wherein the rail system is operably coupled to the frame, and
wherein the movable mount operably couples the storage bin to the rail system.

13. The riding lawn care vehicle of claim 12, wherein the movable mount comprises a planar surface to which the storage bin operably couples to via one or more fasteners.

14. The riding lawn care vehicle of claim 12, wherein the rail system comprises a first rail and a second rail,
wherein the first and second rails are disposed on opposite sides of, and parallel to, a longitudinal axis of the riding lawn care vehicle, and
wherein the first and second rails are disposed in the translation plane.

15. The riding lawn care vehicle of claim 14, wherein the movable mount is operably coupled to the rail system by first, second, third and fourth wheels,
wherein the first, second, third and fourth wheels roll within the rail system to move the movable mount between the forward and aft positions, and
wherein the first and second wheels are operably coupled to the first rail, and the third and fourth wheels are operably coupled to the second rail.

16. The riding lawn care vehicle of claim 15, wherein the first and second rails comprise first and second slots, respectively,
wherein the second and fourth wheels align with the first and second slots, respectively, while the storage bin is in the aft position to enable the storage bin to pivot rearward to the pivoted position about the first and third wheels, and
wherein the second and fourth wheels exit the first and second rails, respectively, through the first and second slots responsive to the storage bin pivoting about the first and third wheels.

17. The riding lawn care vehicle of claim 16, wherein the engagement assembly further comprises first and second frame supports and a bin guide,
wherein the bin guide comprises a first guide member operably coupled to the first rail, a second guide member operably coupled to the second rail and a cross member disposed perpendicularly between the first and second guide members, and
wherein the first and second frame supports operably couple the first and second guide members to the frame.

18. The riding lawn care vehicle of claim 17, wherein the first and second guide members of the bin guide curve downward at roughly 90°such that the cross member is disposed below the rail system, wherein the storage bin rests on the first and second guide members of the bin guide while the storage bin is in the pivoted position.

19. The riding lawn care vehicle of claim 16, wherein the storage bin is removable from the riding lawn care vehicle responsive to the first, second, third and fourth wheels exiting the first and second rails through the first and second slots.

20. The riding lawn care vehicle of claim 11, wherein the movable storage assembly further comprises a retention pin to retain the movable mount in the forward position.
